(19) United States
(12) Patent Application Publication
(10) Pub. No.: US 2015/0022013 A1
(43) Pub. Date: Jan. 22, 2015

(54) POWER TRANSMITTING UNIT (PTU) AND POWER RECEIVING UNIT (PRU), AND COMMUNICATION METHOD OF PTU AND PRU IN WIRELESS POWER TRANSMISSION SYSTEM

(71) Applicant: Samsung Electronics Co., Ltd., Suwon-si (KR)

(72) Inventors: Nam Yun Kim, Seoul (KR); Sang Wook Kwon, Seongnam-si (KR); Hyuk Choon Kwon, Seoul (KR); Ki Young Kim, Yongin-si (KR); Yun Kwon Park, Dongducheon-si (KR); Dal Hoi Shim, Seoul (KR); Byoung Hee Lee, Yongin-si (KR)

(73) Assignee: SAMSUNG ELECTRONICS CO., LTD., Suwon-si (KR)

(21) Appl. No.: 14/322,231

(22) Filed: Jul. 2, 2014

(30) Foreign Application Priority Data
Jul. 22, 2013 (KR) 10-2013-0086341

(51) Int. Cl. H04B 5/00

(52) U.S. Cl. CPC H04B 5/0037
USPC 307/104

(57) ABSTRACT

A communication method of a power transmitting unit (PTU) in a wireless power transmission system includes receiving a connection request signal from each of at least one power receiving unit (PRU), transmitting impedance change information of the at least one PRU to the at least one PRU, sensing a change in an impedance of each of the at least one PRU receiving the impedance change information, and determining whether each of the at least one PRU is connected based on the sensed change in the impedance.

### CROSS-REFERENCE TO RELATED APPLICATIONS

This application claims the benefit under 35 USC 119(a) of Korean Patent Application No. 10-2013-0086341 filed on Jul. 22, 2013, in the Korean Intellectual Property Office, the entire disclosure of which is incorporated herein by reference.

### BACKGROUND

1. Field

The following description relates to a wireless power transmission system using a resonance scheme.

2. Description of Related Art

Wireless power is energy that is transmitted from a power transmitting unit (PTU) to a power receiving unit (PRU) through magnetic resonant coupling. Accordingly, a wireless power transmission system or a wireless power charging system includes a power transmission apparatus configured to wirelessly transmit power, and a power reception apparatus configured to wirelessly receive power.

The power transmission apparatus includes a source resonator, and the power reception apparatus includes a target resonator. Magnetic resonant coupling occurs between the source resonator and the target resonator.

### SUMMARY

This Summary is provided to introduce a selection of concepts in a simplified form that are further described below in the Detailed Description. This Summary is not intended to identify key features or essential features of the claimed subject matter, nor is it intended to be used as an aid in determining the scope of the claimed subject matter.

In one general aspect, a communication method of a power transmitting unit (PTU) in a wireless power transmission system includes receiving a connection request signal from each of at least one power receiving unit (PRU); transmitting impedance change information of the at least one PRU to the at least one PRU; sensing a change in an impedance of each of the at least one PRU receiving the impedance change information; and determining whether each of the at least one PRU is connected based on the sensed change in the impedance.

The receiving may include receiving the connection request signal through an out-of-band communication channel; and the transmitting may include transmitting the impedance change information through the out-of-band communication channel.

The determining may include determining whether each of the at least one PRU is connected based on whether the sensed change in the impedance matches a predetermined pattern.

The PTU may include a table configured to store the impedance change information.

In another general aspect, a communication method of a power receiving unit (PRU) in a wireless power transmission system includes transmitting a power change request to a power transmitting unit (PTU) through a communication channel; receiving a changed power from the PTU; and transmitting a connection request signal through the communication channel in response to the changed power being received from the PTU within a predetermined period of time.

The communication method may further include disconnecting a communication with the PTU through the communication channel in response to the changed power not being received within the predetermined period of time.

In another general aspect, a power transmitting unit (PTU) in a wireless power transmission system includes a connection request receiver configured to receive a connection request signal from each of at least one power receiving unit (PRU); an impedance change information transmitter configured to transmit impedance change information of each of the at least one PRU to each of the at least one PRU; a sensor configured to sense a change in an impedance of each of each of the at least one PRU receiving the impedance change information; and a determiner configured to determine whether each of the at least one PRU is connected based on the sensed change in the impedance.

The connection request receiver may be further configured to transmit the connection request signal through an out-of-band communication channel; and the impedance change information transmitter may be further configured to transmit the impedance change information through the out-of-band communication channel.

The determiner may be further configured to determine whether each of the at least one PRU is connected based on whether the sensed change in the impedance matches a predetermined pattern.

The PTU may include a table configured to store the impedance change information.

In another general aspect, a communication method of a power receiving unit (PRU) in a wireless power transmission system includes transmitting a request to a power transmitting unit (PTU); receiving a response to the request from the PTU; determining whether the PRU may receive wireless power from PTU based on the response; establishing a wireless power transmission network between the PRU and the PTU in response to a result of the determining being that the PRU may receive wireless power from the PTU.

A wireless power transmission network between the PRU and the PTU may not be established in response to a result of the determining being that the PRU may not receive wireless power from the PTU.

The communication method may further include disconnecting a communication channel with the PTU in response to a result of the determining being that the PRU may not receive wireless power from the PTU.

The request may be a connection request signal; and the response may be impedance change information instructing the PRU to change an impedance of the PRU.

The transmitting may include transmitting the connection request signal to the PTU in response to the PRU entering a charging region of the PTU.

The receiving may include sensing a changed impedance of the PRU; and the determining may include determining whether the PRU may receive wireless power from the PTU based on the sensed changed impedance of the PRU.

The determining may further include determining that the PRU may receive wireless power from the PTU in response to the sensed changed impedance of the PRU matching a predetermined pattern.

The request may be a power change request; and the response may be a changed power of the PTU.

The transmitting may include transmitting the power change request to the PTU in response to receiving a wake-up power from the PTU.

The receiving may include determining whether the changed power of the PTU was received within a predetermined period of time after the power change request was transmitted to the PTU; and the determining of whether the PRU may receive wireless power from the PTU may include determining that the PRU may receive wireless power from the PTU in response to a result of the determining of whether the changed power of the PTU was received within the predetermined period of time being that the changed power was received within the predetermined period of time.

Other features and aspects will be apparent from the following detailed description, the drawings, and the claims.

### BRIEF DESCRIPTION OF THE DRAWINGS

FIG. 1 illustrates an example of a wireless power transmission and reception system.

FIGS. 2A and 2B illustrate examples of a distribution of a magnetic field in a feeder and a resonator.

FIGS. 3A and 3B illustrate an example of a wireless power transmission apparatus.

FIG. 4A illustrates an example of a distribution of a magnetic field inside a resonator produced by feeding a feeder.

FIG. 4B illustrates examples of equivalent circuits of a feeder and a resonator.

FIG. 5 illustrates an example of a cross-connection in a multi-source environment.

FIG. 6 illustrates an example of a communication method of a power transmitting unit (PTU).

FIG. 7 illustrates an example of a wireless power transmission system.

FIG. 8 illustrates an example of a communication method of a PTU and a power receiving unit (PRU).

FIG. 9 illustrates an example of a communication method of a PRU.

FIG. 10 illustrates another example of a wireless power transmission system.

FIG. 11 illustrates another example of a communication method of a PTU and a PRU.

FIG. 12 illustrates an example of a PTU.

FIG. 13 illustrates an example of a PRU.

### DETAILED DESCRIPTION

The following detailed description is provided to assist the reader in gaining a comprehensive understanding of the methods, apparatuses, and/or systems described herein. However, various changes, modifications, and equivalents of the methods, apparatuses, and/or systems described herein will be apparent to one of ordinary skill in the art. The sequences of operations described herein are merely examples, and are not limited to that set forth herein, but may be changed as will be apparent to one of ordinary skill in the art, with the exception of operations necessarily occurring in a certain order. Also, descriptions of functions and constructions that are well known to one of ordinary skill in the art may be omitted for increased clarity and conciseness.

Throughout the drawings and the detailed description, the same reference numerals refer to the same elements. The drawings may not be to scale, and the relative size, proportions, and depiction of elements in the drawings may be exaggerated for clarity, illustration, and convenience.

Schemes of communicating between a source and a target, or between the source and another source, may include an in-band communication scheme and an out-of-band communication scheme.

In the in-band communication scheme, the source communicates with the target or the other source using a frequency that is the same as a frequency used for wireless power transmission.

In the out-of-band communication scheme, the source communicates with the target or the other source using a frequency that is different from a frequency used for the wireless power transmission.

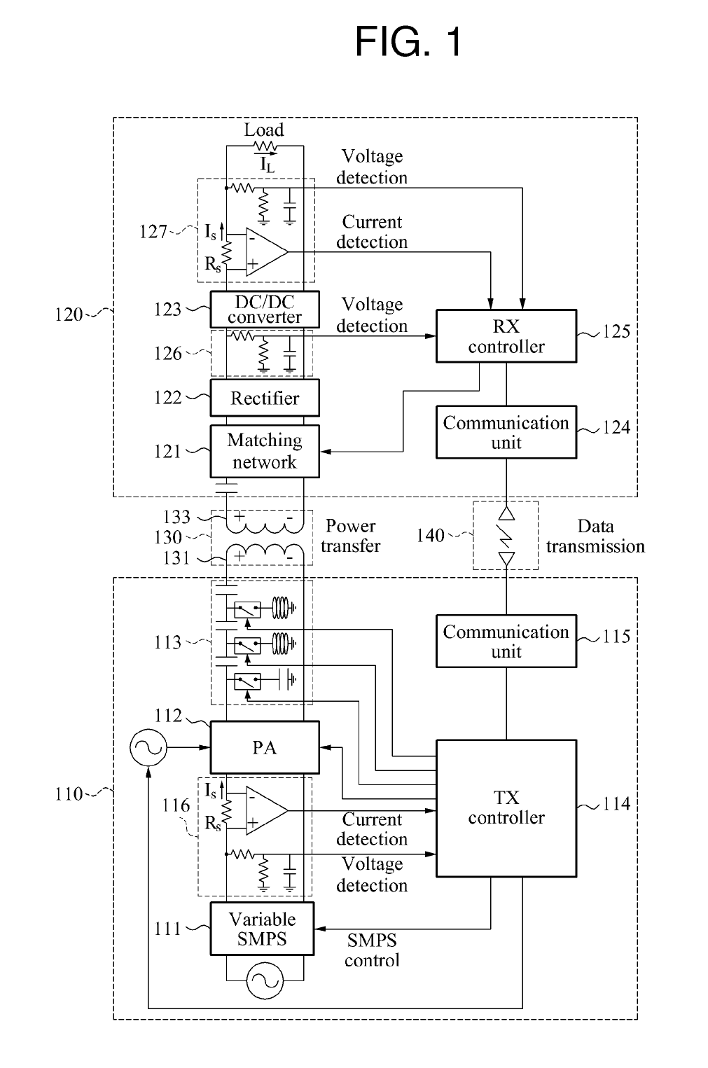

FIG. 1 illustrates an example of a wireless power transmission and reception system.

Referring to FIG. 1, the wireless power transmission and reception system includes a source 110 and a target 120. The source 110 is a device configured to supply wireless power, and may include any electronic device capable of supplying power, for example, a pad, a terminal, a tablet personal computer (PC), a television (TV), a medical device, or an electric vehicle. The target 120 is a device configured to receive wireless power, and may include any electronic device requiring power to operate, for example, a pad, a terminal, a tablet PC, a medical device, an electric vehicle, a washing machine, a radio, or a lighting system.

The source 110 includes a variable switching mode power supply (SMPS) 111, a power amplifier (PA) 112, a matching network 113, a transmission (TX) controller 114 (for example, TX control logic, a communication unit 115, and a power detector 116.

The variable SMPS 111 generates a direct current (DC) voltage by switching an alternating current (AC) voltage having a frequency in a band of tens of hertz (Hz) output from a power supply. The variable SMPS 111 may output a fixed DC voltage, or may output an adjustable DC voltage that may be adjusted under the control of the TX controller 114.

The variable SMPS 111 may control its output voltage supplied to the PA 112 based on a level of power output from the PA 112 so that the PA 112 may operate in a saturation region with a high efficiency at all times, thereby enabling a maximum efficiency to be maintained at all levels of the output power of the PA 112. The PA 112 may be, for example, a Class-E amplifier.

If a fixed SMPS is used instead of the variable SMPS 111, a variable DC-to-DC (DC/DC) converter may be necessary. In this example, the fixed SMPS outputs a fixed DC voltage to the variable DC/DC converter, and the variable DC/DC converter controls its output voltage supplied to the PA 112 based on the level of the power output from the PA 112 so that the PA 112, which may be a Class-E amplifier, may operate in the saturation region with a high efficiency at all times, thereby enabling the maximum efficiency to be maintained at all levels of the output power of the PA 112.

The power detector 116 detects an output current and an output voltage of the variable SMPS 111, and transmits, to the TX controller 114, information on the detected output current and the detected output voltage. Also, the power detector 116 may detect an input current and an input voltage of the PA 112.

The PA 112 generates power by converting a DC voltage having a predetermined level supplied to the PA 112 by the variable SMPS 111 to an AC voltage using a switching pulse signal having a frequency in a band of a few megahertz (MHz) to tens of MHz. For example, the PA 112 may convert a DC voltage supplied to the PA 112 to an AC voltage having a reference resonant frequency F_{Ref}, and may generate communication power used for communication, and/or charging power used for charging. The communication power and the charging power may be used in a plurality of targets.

If a high power from a few kilowatts kW to tens of kW is to be transmitted using a resonant frequency in a band of tens of kilohertz (kHz) to hundreds of kHz, the PA 112 may be omitted, and power may be supplied to a source resonator 131 from the variable SMPS 111 or a high-power power supply. For example, an inverter may be used in lieu of the PA 112. The inverter may convert a DC power supplied from the high-power power supply to an AC power. The inverter may convert the power by converting a DC voltage having a predetermined level to AC voltage using a switching pulse signal having a frequency in a band of tens of kHz to hundreds of kHz. For example, the inverter may convert the DC voltage having the predetermined level to an AC voltage having a resonant frequency of the source resonator 131 having a frequency in a band of tens of kHz to hundreds of kHz.

As used herein, the term “communication power” refers to a low power of 0.1 milliwatt (mW) to 1 mW. The term “charging power” refers to a high power of a few mW to tens of kW consumed by a load of a target. As used herein, the term “charging” refers to supplying power to a unit or element that is configured to charge a battery or other rechargeable device. Additionally, the term “charging” refers to supplying power to a unit or element configured to consume power. For example, the term “charging power” may refer to power consumed by a target while operating, or power used to charge a battery of the target. The unit or element may be, for example, a battery, a display device, a sound output circuit, a main processor, or any of various types of sensors.

As used herein, the term “reference resonant frequency” refers to a resonant frequency nominally used by the source 110, and the term “tracking frequency” refers to a resonant frequency used by the source 110 that has been adjusted based on a preset scheme.

The TX controller 114 may detect a reflected wave of the communication power or the charging power, and may detect mismatching that occurs between a target resonator 133 and the source resonator 131 based on the detected reflected wave. To detect the mismatching, for example, the TX controller 114 may detect an envelope of the reflected wave, a power amount of the reflected wave, or any other characteristic of the reflected wave that is affected by mismatching.

The matching network 113 compensates for impedance mismatching between the source resonator 131 and the target resonator 133 to achieve optimal matching under the control of the TX controller 114. The matching network 113 includes at least one inductor and at least one capacitor each connected to a respective switch controlled by the TX controller 114.

If a high power is to be transmitted using a resonant frequency in a band of tens of kHz to hundreds of kHz, the matching network 113 may be omitted from the source 110 because the effect of the matching network 113 may be reduced when transmitting the high power.

The TX controller 114 may calculate a voltage standing wave ratio (VSWR) based on a voltage level of the reflected wave and a level of an output voltage of the source resonator 131 or the PA 112. In one example, if the VSWR is greater than a predetermined value, the TX controller 114 may determine that a mismatch is detected between the source resonator 131 and the target resonator 133.

In another example, if the TX controller 114 detects that the VSWR is greater than the predetermined value, the TX controller 114 may calculate a wireless power transmission efficiency for each of N tracking frequencies, determine a tracking frequency F_{Best} providing the best wireless power transmission efficiency among the N tracking frequencies, and adjust the reference resonant frequency F_{Ref} to the tracking frequency F_{Best}. The N tracking frequencies may be set in advance.

The TX controller 114 may adjust a frequency of the switching pulse signal used by the PA 112. The frequency of the switching pulse signal may be determined under the control of the TX controller 114. For example, by controlling the PA 112, the TX controller 114 may generate a modulated signal to be transmitted to the target 120. In other words, the TX controller 114 may transmit a variety of data to the target 120 using in-band communication. The TX controller 114 may also detect a reflected wave, and may demodulate a signal received from the target 120 from an envelope of the detected reflected wave.

The TX controller 114 may generate a modulated signal for in-band communication using various methods. For example, the TX controller 114 may generate the modulated signal by turning the switching pulse signal used by the PA 112 on and off, by performing delta-sigma modulation, or by any other modulation method known to one of ordinary skill in the art. Additionally, the TX controller 114 may generate a pulse-width modulated (PWM) signal having a predetermined envelope.

The TX controller 114 may determine an initial wireless power to be transmitted to the target 120 based on a change in a temperature of the source 110, a battery state of the target 120, a change in an amount of power received by the target 120, and/or a change in a temperature of the target 120.

The source 110 may further include a temperature measurement sensor (not illustrated) configured to detect a change in temperature. The source 110 may receive from the target 120 information regarding the battery state of the target 120, the change in the amount of power received by the target 120, and/or the change in the temperature of the target 120 by communicating with the target 120. The source 110 may detect the change in the temperature of the target 120 based on the information received from the target 120.

The TX controller 114 may adjust a voltage supplied to the PA 112 based on the change in the temperature of the target 120 using a lookup table (LUT). The LUT may store a level of the voltage to be supplied to the PA 112 based on the change in the temperature of the source 110. For example, when the temperature of the source 110 rises, the TX controller 114 may reduce the voltage to be supplied to the PA 112 by controlling the variable SMPS 111.

The communication unit 115 may perform out-of-band communication using a separate communication channel. The communication unit 115 may include a communication module, such as a ZigBee module, a Bluetooth module, or any other communication module known to one of ordinary skill in the art that the communication unit 115 may use to transmit or receive data 140 to or from the target 120 using the out-of-band communication.

The source resonator 131 transmits electromagnetic energy 130 to the target resonator 133. For example, the source resonator 131 may transmit the communication power or the charging power to the target 120 via magnetic coupling with the target resonator 133.

The source resonator 131 may be made of a superconducting material. Also, although not illustrated in FIG. 1, the source resonator 131 may be disposed in a container of refrigerant to enable the source resonator 131 to maintain a superconducting state. A heated refrigerant that has transitioned to a gaseous state may be liquefied to a liquid state by a cooler. The target resonator 133 may also be made of a superconducting material. In this instance, the target resonator 133 may also be disposed in a container of refrigerant to enable the target resonator 133 to maintain a superconducting state.

As illustrated in FIG. 1, the target 120 includes a matching network 121, a rectifier 122, a DC/DC converter 123, a communication unit 124, a reception (RX) controller 125 (for example, RX control logic), a voltage detector 126, and a power detector 127.

The target resonator 133 receives the electromagnetic energy 130 from the source resonator 131. For example, the target resonator 133 may receive the communication power or the charging power from the source 110 via a magnetic coupling with the source resonator 131. Additionally, the target resonator 133 may receive data from the source 110 using the in-band communication.

The target resonator 133 may receive the initial wireless power determined by the TX controller 114 based on the change in the temperature of the source 110, the battery state of the target 120, the change in the amount of power received by the target 120, and/or the change in the temperature of the target 120.

The matching network 121 matches an input impedance viewed from the source 110 to an output impedance viewed from a load of the target 120. The matching network 121 may be configured to have at least one capacitor and at least one inductor.

The rectifier 122 generates a DC voltage by rectifying an AC voltage received by the target resonator 133.

The DC/DC converter 123 adjusts a level of the DC voltage output from the rectifier 122 based on a voltage required by the load. As an example, the DC/DC converter 123 may adjust the level of the DC voltage output from the rectifier 122 to a level in a range of 3 volts (V) to 10 V.

The voltage detector 126 detects a voltage of an input terminal of the DC/DC converter 123, and the power detector 127 detects a current and a voltage of an output terminal of the DC/DC converter 123. The detected voltage of the input terminal may be used to calculate a wireless power transmission efficiency of the power received from the source 110. Additionally, the detected current and the detected voltage of the output terminal may be used by the RX controller 125 to calculate an amount of power actually transferred to the load. The TX controller 114 of the source 110 may calculate an amount of power that needs to be transmitted by the source 110 to the target 120 based on an amount of power required by the load and the amount of power actually transferred to the load.

If the amount of the power actually transferred to the load calculated by the RX controller 125 is transmitted to the source 110 by the communication unit 124, the source 110 may calculate an amount of power that needs to be transmitted to the target 120, and may control either one or both of the variable SMPS 111 and the PA 112 to generate an amount of power that will enable the calculated amount of power to be transmitted by the source 110.

The RX controller 125 may perform in-band communication to transmit and receive data using a resonant frequency. During the in-band communication, the RX controller 125 may demodulate a received signal by detecting a signal between the target resonator 133 and the rectifier 122, or detecting an output signal of the rectifier 122. In particular, the RX controller 125 may demodulate a message received using the in-band communication.

Additionally, the RX controller 125 may adjust an input impedance of the target resonator 133 using the matching network 121 to modulate a signal to be transmitted to the source 110. For example, the RX controller 125 may adjust the matching network 121 to increase the impedance of the target resonator 133 so that a reflected wave will be detected by the TX controller 114 of the source 110. Depending on whether the reflected wave is detected, the TX controller 114 of the source 110 may detect a first value, for example a binary number “0,” or a second value, for example a binary number “1.” For example, when the reflected wave is detected, the TX controller 114 may detect “0”, and when the reflected wave is not detected, the TX controller 114 may detect “1”. Alternatively, when the reflected wave is detected, the TX controller 114 may detect “1”, and when the reflected wave is not detected, the TX controller 114 may detect “0”.

The communication unit 124 of the target 120 may transmit a response message to the communication unit 115 of the source 110. For example, the response message may include any one or any combination of a product type of the target 120, manufacturer information of the target 120, a model name of the target 120, a battery type of the target 120, a charging scheme of the target 120, an impedance value of a load of the target 120, information on characteristics of the target resonator 133 of the target 120, information on a frequency band used by the target 120, an amount of power consumed by the target 120, an identifier (ID) of the target 120, product version information of the target 120, standard information of the target 120, and any other information about the target 120.

The communication unit 124 may perform out-of-band communication using a separate communication channel. For example, the communication unit 124 may include a communication module, such as a ZigBee module, a Bluetooth module, or any other communication module known to one of ordinary skill in the art that the communication unit 124 may use to transmit and receive the data 140 to and from the source 110 using the out-of-band communication.

The communication unit 124 may receive a wake-up request message from the source 110, and the power detector 127 may detect an amount of power received by the target resonator 133. The communication unit 124 may transmit to the source 110 information on the detected amount of the power received by the target resonator 133. The information on the detected amount of the power received by the target resonator 133 may include, for example, an input voltage value and an input current value of the rectifier 122, an output voltage value and an output current value of the rectifier 122, an output voltage value and an output current value of the DC/DC converter 123, and any other information about the detected amount of the power received by the target resonator 133.

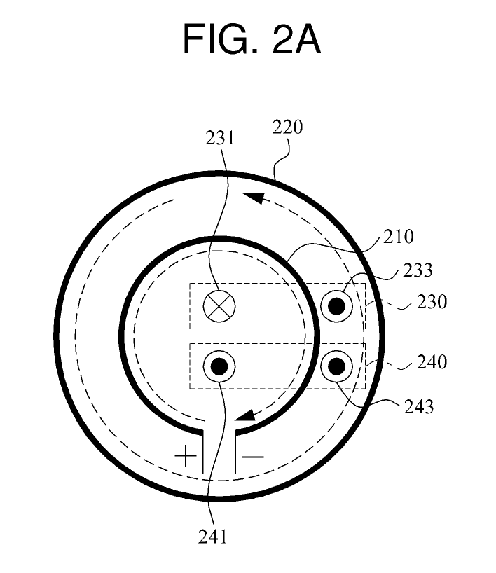

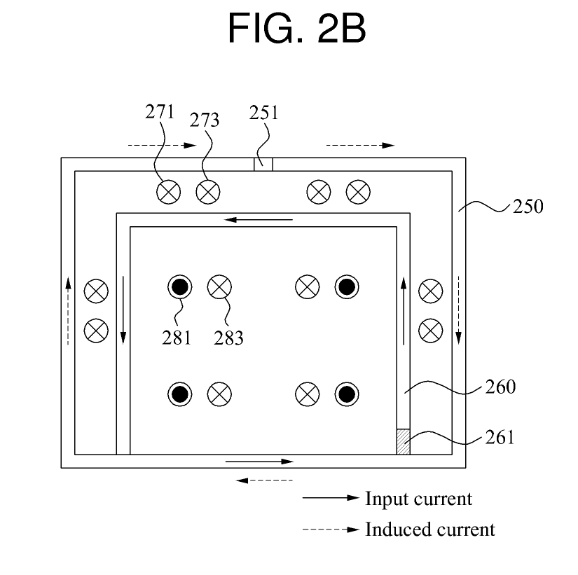

In the following description of FIGS. 2A through 4B, unless otherwise indicated, the term “resonator” may refer to both a source resonator and a target resonator. The resonator of FIGS. 2A through 4B may be used as the resonators described with respect to FIGS. 1 and 5-13.

FIGS. 2A and 2B illustrate examples of a distribution of a magnetic field in a feeder and a resonator. When a resonator receives power supplied through a separate feeder, magnetic fields are generated in both the feeder and the resonator. A source resonator and a target resonator may each have a dual loop structure including an external loop and an internal loop.

FIG. 2A is a diagram illustrating an example of a structure of a wireless power transmitter in which a feeder 210 and a resonator 220 do not have a common ground. Referring to FIG. 2A, when an input current flows into the feeder 210 through a terminal labeled “+” and out of the feeder 210 through a terminal labeled “−”, a magnetic field 230 is generated by the input current. A direction 231 of the magnetic field 230 inside the feeder 210 is into the plane of FIG. 2A, and is opposite to a direction 233 of the magnetic field 230 outside the feeder 210. The magnetic field 230 generated by the feeder 210 induces a current to flow in the resonator 220. A direction of the induced current in the resonator 220 is opposite to a direction of the input current in the feeder 210 as indicated by the dashed lines with arrowheads in FIG. 2A.

The induced current in the resonator 220 generates a magnetic field 240. Directions of the magnetic field 240 generated by the resonator 220 are the same at all positions inside the resonator 220, and are out of the plane of FIG. 2A. Accordingly, a direction 241 of the magnetic field 240 generated by the resonator 220 inside the feeder 210 is the same as a direction 243 of the magnetic field 240 generated by the resonator 220 outside the feeder 210.

Consequently, when the magnetic field 230 generated by the feeder 210 and the magnetic field 240 generated by the resonator 220 are combined, a strength of the total magnetic field decreases inside the feeder 210, but increases outside the feeder 210. Accordingly, when power is supplied to the resonator 220 through the feeder 210 configured as illustrated in FIG. 2A, the strength of the total magnetic field decreases in the portion of the resonator 220 inside the feeder 210, but increases in the portion of the resonator 220 outside the feeder 210. When a distribution of a magnetic field is random or not uniform in the resonator 220, it may be difficult to perform impedance matching because an input impedance may frequently vary. Additionally, when the strength of the total magnetic field increases, a wireless power efficiency increases. Conversely, when the strength of the total magnetic field decreases, the wireless power transmission efficiency decreases. Accordingly, the wireless power transmission efficiency may be reduced on average.

FIG. 2B illustrates an example of a structure of a wireless power transmission apparatus in which a resonator 250 and a feeder 260 have a common ground. The resonator 250 includes a capacitor 251. The feeder 260 receives a radio frequency (RF) signal via a port 261. When the RF signal is input to the feeder 260, an input current is generated in the feeder 260. The input current flowing in the feeder 260 generates a magnetic field, and a current is induced in the resonator 250 by the magnetic field. Additionally, another magnetic field is generated by the induced current flowing in the resonator 250. In this example, a direction of the input current flowing in the feeder 260 is opposite to a direction of the induced current flowing in the resonator 250. Accordingly, in a region between the resonator 250 and the feeder 260, a direction 271 of the magnetic field generated by the input current is the same as a direction 273 of the magnetic field generated by the induced current, and thus the strength of the total magnetic field increases. Conversely, inside the feeder 260, a direction 281 of the magnetic field generated by the input current is opposite to a direction 283 of the magnetic field generated by the induced current, and thus the strength of the total magnetic field decreases. Therefore, the strength of the total magnetic field decreases in a portion of the resonator 250 inside the feeder 260, but increases in a portion of the resonator 250 outside the feeder 260.

An input impedance may be adjusted by adjusting an internal area of the feeder 260. The input impedance is an impedance viewed in a direction from the feeder 260 to the resonator 250. When the internal area of the feeder 260 increases, the input impedance increases, and when the internal area of the feeder 260 decreases, the input impedance decreases. However, if the magnetic field is randomly or not uniformly distributed in the resonator 250, the input impedance may vary based on a location of a target even if the internal area of the feeder 260 has been adjusted to adjust the input impedance to match an output impedance of a power amplifier for a specific location of the target. Accordingly, a separate matching network may be needed to match the input impedance to the output impedance of the power amplifier. For example, when the input impedance increases, a separate matching network may be needed to match the increased input impedance to a relatively low output impedance of the power amplifier.

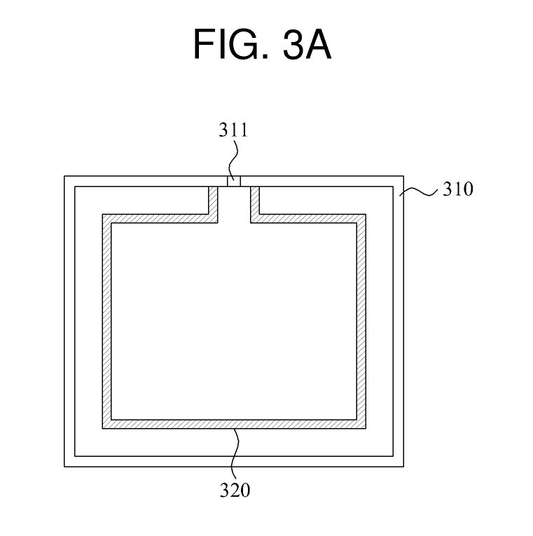

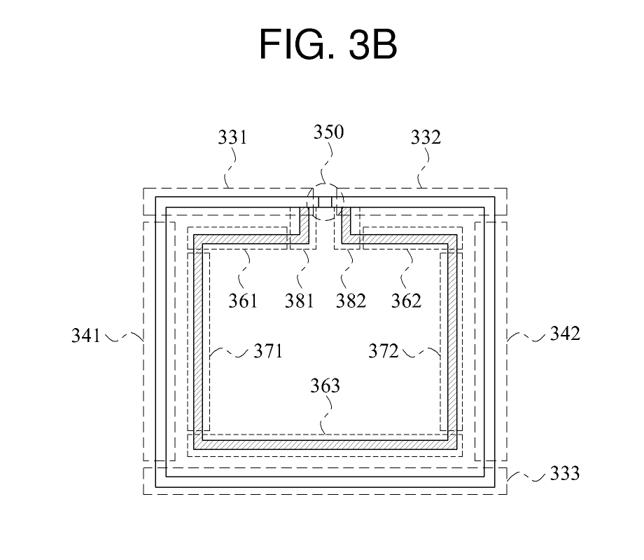

FIGS. 3A and 3B illustrate an example of a wireless power transmission apparatus.

Referring to FIG. 3A, the wireless power transmission apparatus includes a resonator 310 and a feeder 320. The resonator 310 includes a capacitor 311. The feeder 320 is electrically connected to both ends of the capacitor 311.

FIG. 3B illustrates a structure of the wireless power transmission apparatus of FIG. 3A in greater detail. The resonator 310 includes a first transmission line (not identified by a reference numeral in FIG. 3B, but formed by various elements in FIG. 3B as discussed below), a first conductor 341, a second conductor 342, and at least one capacitor 350.

The capacitor 350 is connected in series between a first signal conducting portion 331 and a second signal conducting portion 332 in the first transmission line, causing an electric field to be concentrated in the capacitor 350. In general, a transmission line includes at least one conductor disposed in an upper portion of the transmission line, and at least one conductor disposed in a lower portion of the transmission line. A current may flow through the at least one conductor disposed in the upper portion of the transmission line, and the at least one conductor disposed in the lower portion of the transmission line may be electrically grounded. In the example in FIG. 3B, a conductor disposed in the upper portion of the first transmission line is separated into two portions that will be referred to as the first signal conducting portion 331 and the second signal conducting portion 332, and a conductor disposed in the lower portion of the first transmission line will be referred to as a first ground conducting portion 333.

As illustrated in FIG. 3B, the resonator 310 has a generally two-dimensional (2D) structure. The first transmission line includes the first signal conducting portion 331 and the second signal conducting portion 332 in the upper portion of the first transmission line, and the first ground conducting portion 333 in the lower portion of the first transmission line. The first signal conducting portion 331 and the second signal conducting portion 332 are disposed to face the first ground conducting portion 333. A current flows through the first signal conducting portion 331 and the second signal conducting portion 332.

Additionally, one end of the first signal conducting portion 331 is connected to one end of the first conductor 341, the other end of the first signal conducting portion 331 is connected to one end of the capacitor 350, and the other end of the first conductor 341 is connected to one end of the first ground conducting portion 333. One end of the second signal conducting portion 332 is connected to one end of the second conductor 342, the other end of the second signal conducting portion 332 is connected to the other end of the capacitor 350, and the other end of the second conductor 342 is connected to the other end of the first ground conducting portion 333. Accordingly, the first signal conducting portion 331, the second signal conducting portion 332, the first ground conducting portion 333, the first conductor 341, and the second conductor 342 are connected to each other, causing the resonator 310 to have an electrically closed loop structure. The term “loop structure” includes a polygonal structure, a circular structure, a rectangular structure, and any other geometrical structure that is closed, i.e., a geometrical structure that does not have any opening in its perimeter. The expression “having a loop structure” indicates a structure that is electrically closed.

The capacitor 350 is inserted into an intermediate portion of the first transmission line. In the example in FIG. 3B, the capacitor 350 is inserted into a space between the first signal conducting portion 331 and the second signal conducting portion 332. The capacitor 350 may be a lumped element capacitor, a distributed element capacitor, or any other type of capacitor known to one of ordinary skill in the art. For example, a distributed element capacitor may include zigzagged conductor lines and a dielectric material having a high permittivity disposed between the zigzagged conductor lines.

The capacitor 350 inserted into the first transmission line may cause the resonator 310 to have a characteristic of a metamaterial. A metamaterial is a material having an electrical characteristic that is not found in nature, and thus may have an artificially designed structure. All materials existing in nature have a magnetic permeability and a permittivity. Most materials have a positive magnetic permeability and a positive permittivity.

In the case of most materials, a right-hand rule may be applied to an electric field, a magnetic field, and a Poynting vector, so the corresponding materials may be referred to as right-handed materials (RHMs). However a metamaterial having a magnetic permeability and/or a permittivity not found in nature may be classified into an epsilon negative (ENG) material, a mu negative (MNG) material, a double negative (DNG) material, a negative refractive index (NRI) material, a left-handed (LH) material, and any other metamaterial classification known to one of ordinary skill in the art based on a sign of the permittivity of the metamaterial and a sign of the magnetic permeability of the metamaterial.

If the capacitor 350 is a lumped element capacitor and the capacitance of the capacitor 350 is appropriately determined, the resonator 310 may have a characteristic of a metamaterial. If the resonator 310 is caused to have a negative magnetic permeability by appropriately adjusting the capacitance of the capacitor 350, the resonator 310 may also be referred to as an MNG resonator. Various criteria may be applied to determine the capacitance of the capacitor 350. For example, the various criteria may include a criterion for enabling the resonator 310 to have the characteristic of the metamaterial, a criterion for enabling the resonator 310 to have a negative magnetic permeability at a target frequency, a criterion for enabling the resonator 310 to have a zeroth-order resonance characteristic at the target frequency, and any other suitable criterion. Based on any one or any combination of the aforementioned criteria, the capacitance of the capacitor 350 may be appropriately determined.

The resonator 310, hereinafter referred to as the MNG resonator 310, may have a zeroth-order resonance characteristic of having a resonant frequency when a propagation constant is “0”. When the resonator 310 has the zeroth-order resonance characteristic, the resonant frequency is independent of a physical size of the MNG resonator 310. The resonant frequency of the MNG resonator 310 having the zeroth-order resonance characteristic may be changed without changing the physical size of the MNG resonator 310 by changing the capacitance of the capacitor 350.

In a near field, the electric field is concentrated in the capacitor 350 inserted into the first transmission line, causing the magnetic field to become dominant in the near field. The MNG resonator 310 has a relatively high Q-factor when the capacitor 350 is a lumped element capacitor, thereby increasing a wireless power transmission efficiency. The Q-factor indicates a level of an ohmic loss or a ratio of a reactance with respect to a resistance in the wireless power transmission. As will be understood by one of ordinary skill in the art, the wireless power transmission efficiency will increase as the Q-factor increases.

Although not illustrated in FIG. 3B, a magnetic core passing through the MNG resonator 310 may be provided to increase a wireless power transmission distance.

Referring to FIG. 3B, the feeder 320 includes a second transmission line (not identified by a reference numeral in FIG. 3B, but formed by various elements in FIG. 3B as discussed below), a third conductor 371, a fourth conductor 372, a fifth conductor 381, and a sixth conductor 382.

The second transmission line includes a third signal conducting portion 361 and a fourth signal conducting portion 362 in an upper portion of the second transmission line, and a second ground conducting portion 363 in a lower portion of the second transmission line. The third signal conducting portion 361 and the fourth signal conducting portion 362 are disposed to face the second ground conducting portion 363. A current flows through the third signal conducting portion 361 and the fourth signal conducting portion 362.

Additionally, one end of the third signal conducting portion 361 is connected to one end of the third conductor 371, the other end of the third signal conducting portion 361 is connected to one end of the fifth conductor 381, and the other end of the third conductor 371 is connected to one end of the second ground conducting portion 363. One end of the fourth signal conducting portion 362 is connected to one end of the fourth conductor 372, the other end of the fourth signal conducting portion 362 is connected to one end of the sixth conductor 382, and the other end of the fourth conductor 372 is connected to the other end of the second ground conducting portion 363. The other end of the fifth conductor 381 is connected to the first signal conducting portion 331 at or near where the first signal conducting portion 331 is connected to one end of the capacitor 350, and the other end of the sixth conductor 382 is connected to the second signal conducting portion 332 at or near where the second signal conducting portion 332 is connected to the other end of the capacitor 350. Thus, the fifth conductor 381 and the sixth conductor 382 are connected in parallel with both ends of the capacitor 350. The fifth conductor 381 and the sixth conductor 382 may be used as input ports to receive an RF signal as an input.

Accordingly, the third signal conducting portion 361, the fourth signal conducting portion 362, the second ground conducting portion 363, the third conductor 371, the fourth conductor 372, the fifth conductor 381, the sixth conductor 382, and the resonator 310 are connected to each other, causing the resonator 310 and the feeder 320 to have an electrically closed loop structure. The term “loop structure” includes a polygonal structure, a circular structure, a rectangular structure, and the any other geometrical structure that is closed, i.e., a geometrical structure that does not have any opening in its perimeter. The expression “having a loop structure” indicates a structure that is electrically closed.

If an RF signal is input to the fifth conductor 381 or the sixth conductor 382, an input current flows in the feeder 320 and the resonator 310, generating a magnetic field that induces a current in the resonator 310. A direction of the input current flowing in the feeder 320 is the same as a direction of the induced current flowing in the resonator 310, thereby causing a strength of the total magnetic field in the resonator 310 to increase inside the feeder 320, but decrease outside the feeder 320.

An input impedance is determined by an area of a region between the resonator 310 and the feeder 320. Accordingly, a separate matching network used to match the input impedance to an output impedance of a power amplifier may not be needed. However, even if a matching network is used, the input impedance may be adjusted by adjusting a size of the feeder 320, and accordingly a structure of the matching network may be simplified. The simplified structure of the matching network reduces a matching loss of the matching network.

The second transmission line, the third conductor 371, the fourth conductor 372, the fifth conductor 381, and the sixth conductor 382 of the feeder 320 may have the same structure as the resonator 310. For example, if the resonator 310 has a loop structure, the feeder 320 may also have a loop structure. As another example, if the resonator 310 has a circular structure, the feeder 320 may also have a circular structure.

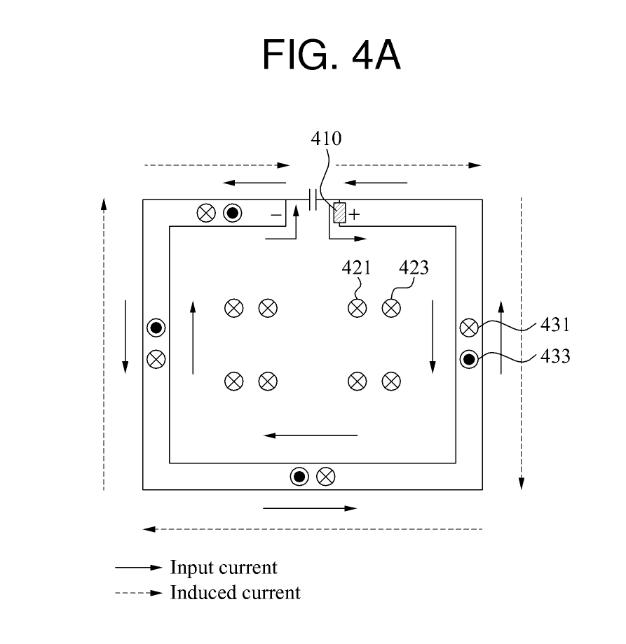

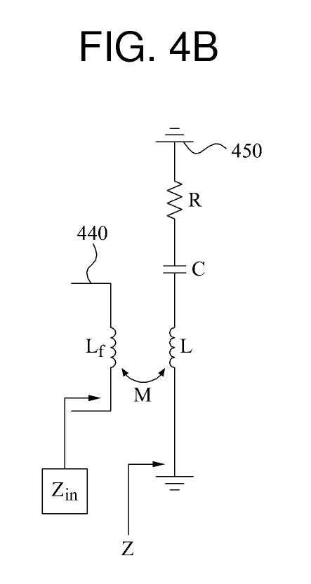

FIG. 4A illustrates an example of a distribution of a magnetic field inside a resonator produced by feeding a feeder. FIG. 4A more simply illustrates the resonator 310 and the feeder 320 of FIGS. 3A and 3B, and the names and the reference numerals of the various elements in FIG. 3B will be used in the following description of FIG. 4A for ease of description.

A feeding operation may be an operation of supplying power to a source resonator in wireless power transmission, or an operation of supplying AC power to a rectifier in the wireless power transmission. FIG. 4A illustrates a direction of an input current flowing in the feeder 320, and a direction of an induced current induced in the resonator 310. Additionally, FIG. 4A illustrates a direction of a magnetic field generated by the input current of the feeder, and a direction of a magnetic field generated by the induced current of the resonator 310.

Referring to FIG. 4A, the fifth conductor 381 or the sixth conductor 382 of the feeder 320 may be used as an input port 410. In FIG. 4A, the sixth conductor 382 is being used as the input port 410. The input port 410 receives an RF signal as an input. The RF signal may be output from a power amplifier. The power amplifier may increase or decrease an amplitude of the RF signal based on a power requirement of a target. The RF signal received by the input port 410 is represented in FIG. 4A as an input current flowing in the feeder. The input current flows in a clockwise direction in the feeder 320 along the second transmission line of the feeder 320. The fifth conductor 381 and the sixth conductor 382 of the feeder 320 are electrically connected to the resonator 310. More particularly, the fifth conductor 381 is connected to the first signal conducting portion 331 of the resonator 310, and the sixth conductor 382 of the feeder 320 is connected to the second signal conducting portion 332 of the resonator 310. Accordingly, the input current flows in both the resonator 310 and the feeder 320. The input current flows in a counterclockwise direction in the resonator 310. The input current flowing in the resonator 310 generates a magnetic field, and the magnetic field induces a current in the resonator 310. The induced current flows in a clockwise direction in the resonator 310. The induced current in the resonator 310 supplies energy to the capacitor 311 of the resonator 310, and also generates a magnetic field. In this example, the input current flowing in the feeder 320 and the resonator 310 is indicated by the solid lines with arrowheads in FIG. 4A, and the induced current flowing in the resonator 310 is indicated by the dashed lines with arrowheads in FIG. 4A.

A direction of a magnetic field generated by a current is determined based on the right-hand rule. As illustrated in FIG. 4A, inside the feeder 320, a direction 421 of the magnetic field generated by the input current flowing in the feeder is the same as a direction 423 of the magnetic field generated by the induced current flowing in the resonator 310. Accordingly, the strength of the total magnetic field increases inside the feeder 320.

In contrast, as illustrated in FIG. 4A, in a region between the feeder 320 and the resonator 310, a direction 433 of the magnetic field generated by the input current flowing in the feeder 320 is opposite to a direction 431 of the magnetic field generated by the induced current flowing in the resonator 310. Accordingly, the strength of the total magnetic field decreases in the region between the feeder 320 and the resonator 310.

Typically, in a resonator having a loop structure, a strength of a magnetic field decreases in the center of the resonator, and increases near an outer periphery of the resonator. However, referring to FIG. 4A, since the feeder 320 is electrically connected to both ends of the capacitor 311 of the resonator 310, the direction of the induced current in the resonator 310 is the same as the direction of the input current in the feeder 320. Since the induced current in the resonator 310 flows in the same direction as the input current in the feeder 320, the strength of the total magnetic field increases inside the feeder 320, and decreases outside the feeder 320. As a result, due to the feeder 320, the strength of the total magnetic field increases in the center of the resonator 310 having the loop structure, and decreases outside the resonator 310, thereby compensating for the normal characteristic of the resonator 310 having the loop structure in which the strength of the magnetic field decreases in the center of the resonator 310, and increases near the outer periphery of the resonator 310. Thus, the strength of the total magnetic field may be constant inside the resonator 310.

A wireless power transmission efficiency of transmitting power from a source resonator to a target resonator is proportional to the strength of the total magnetic field generated in the source resonator. In other words, when the strength of the total magnetic field increases in the center of the resonator, the wireless power transmission efficiency also increases.

FIG. 4B illustrates an example of equivalent circuits of a feeder and a resonator.

Referring to FIG. 4B, a feeder 440 and a resonator 450 may be represented by the equivalent circuits in FIG. 4B. The feeder 440 is represented as an inductor having an inductance L_{f}, and the resonator 450 is represented as a series connection of an inductor having an inductance L coupled to the inductance L_{f} of the feeder 440 by a mutual inductance M, a capacitor having a capacitance C, and a resistor having a resistance R. An example of an input impedance Zᵢₙ viewed in a direction from the feeder 440 to the resonator 450 may be expressed by the following Equation 1.

$${Z}_{in} = \frac{{( ω M )}^{2}}{Z} \qquad ( 1 )$$

In Equation 1, M denotes a mutual inductance between the feeder 440 and the resonator 450, ω denotes a resonant frequency between the feeder 440 and the resonator 450, and Z denotes an impedance viewed in a direction from the resonator 450 to a target. As can be seen from Equation 1, the input impedance Zᵢₙ is proportional to the square of the mutual inductance M. Accordingly, the input impedance Zᵢₙ may be adjusted by adjusting the mutual inductance M between the feeder 440 and the resonator 450. The mutual inductance M depends on an area of a region between the feeder 440 and the resonator 450. The area of the region between the feeder 440 and the resonator 450 may be adjusted by adjusting a size of the feeder 440, thereby adjusting the mutual inductance M and the input impedance Zᵢₙ. Since the input impedance Zᵢₙ may be adjusted by adjusting the size of the feeder 440, and it may be unnecessary to use a separate matching network to perform impedance matching with an output impedance of a power amplifier.

In the resonator 450 and the feeder 440 included in a wireless power reception apparatus, a magnetic field may be distributed as illustrated in FIG. 4A. The resonator 450 may operate as a target resonator 450. For example, the target resonator 450 may receive wireless power from a source resonator through magnetic coupling with the source resonator. The received wireless power induces a current in the target resonator 450. The induced current in the target resonator 450 generates a magnetic field, which induces a current in the feeder 440. If the target resonator 450 is connected to the feeder 440 as illustrated in FIG. 4A, the induced current in the target resonator 450 will flow in the same direction as the induced current in the feeder 440. Accordingly, for the reasons discussed above in connection with FIG. 4A, the strength of the total magnetic field will increase inside the feeder 440, but will decrease in a region between the feeder 440 and the target resonator 450.

Cross-Connection in Multi-Source Environment

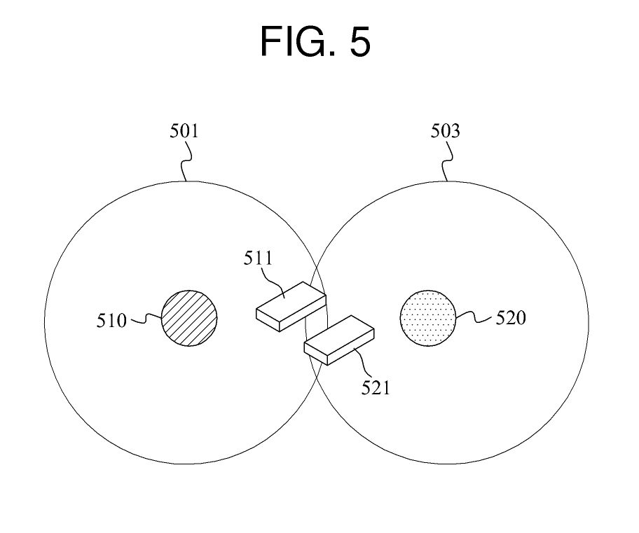

FIG. 5 illustrates an example of a cross-connection in a multi-source environment.

Referring to FIG. 5, the multi-source environment includes a plurality of power transmitting units (PTUs), for example, PTUs 510 and 520.

An efficient power transmission region 501 of the PTU 510 and an efficient power transmission region 503 of the PTU 520 may be set so that the efficient power transmission regions 501 and 503 overlap as shown in FIG. 5, or do not overlap.

The term “efficient power transmission region” denotes a region in which a predetermined wireless power transmission efficiency is guaranteed. For example, wireless power may be efficiently received from the PTU 510 by a power receiving unit (PRU) 511 since the PRU 511 is located within the efficient power transmission region 501.

The PTUs 510 and 520 may be individually installed in separate apparatuses, or may be installed as respective pads in a single apparatus.

In an example in which the multi-source environment uses an out-of-band communication scheme, a communication coverage of the PTU 510 may be set to be wider than the efficient power transmission region 501. Thus, a device located near a boundary between the efficient power transmission regions 501 and 503 may receive wake-up power from both the PTUs 510 and 520. The wake-up power is used to activate a communication function and a control function of a PRU.

In the multi-source environment, the PTUs 510 and 520 may be required to detect a PRU based on at least a wireless power transmission efficiency, and perhaps other criteria. The PTUs 510 and 520 may be required to block connection of a PRU based on circumstances.

Additionally, in the multi-source environment, the PRUs 511 and 521 may be required to connect to a PTU with a high wireless power transmission efficiency.

As illustrated in FIG. 5, the PRUs 511 and 521 are located near the boundary between the efficient power transmission regions 501 and 503.

The PRUs 511 and 521 receive wake-up power from at least one of the PTUs 510 and 520. A communication function and a control function of each of the PRUs 511 and 521 are activated by the wake-up power.

The PRUs 511 and 521 receive notice information from each of the PTUs 510 and 520. The PRUs 511 and 521 compare received signal strength indicator (RSSI) values of received signals in the notice information, and transmit a search signal to a PTU having a higher RSSI value. The notice information may include, for example, a network ID used to identify the PTUs 510 and 520.

When the communication function and the control function of each of the PRUs 511 and 521 are activated, each of the PRUs 511 and 521 transmits a search signal. For example, a search signal transmitted by the PRU 511 may be an advertisement signal for the PRU 511, and may include information regarding the PRU 511. The information regarding the PRU 511 may include, for example, information regarding a charging state of the PRU 511, impedance change information of the PRU 511, and any other information regarding the PRU 511. Additionally, a search signal transmitted by the PRU 521 may be an advertisement signal for the PRU 521, and may include information regarding the PRU 521.

Since the communication coverage of the PTU 510 is wider than the efficient power transmission region 501, the PTU 510 may receive a search signal from each of the PRUs 511 and 521.

The PTU 510 compares RSSI values of search signals received from the PRUs 511 and 521 with a preset value, and determines whether the PRUs 511 and 521 are cross-connected based on a result of the comparison. The PTU 520 compares RSSI values of search signals received from the PRUs 511 and 521 with a preset value, and determines whether the PRUs 511 and 521 are cross-connected based on a result of the comparison.

A cross-connection is a situation in which a search signal is detected from a PRU located in an efficient power transmission region of each of different PTUs, and in which a communication network is formed between the PRU and the different PTUs.

In an example in which the efficient power transmission regions 501 and 503 do not overlap each other, and in which the PRUs 511 and 521 are respectively located in the efficient power transmission regions 501 and 503, in a normal connection state, the PRU 511 forms a communication network with the PTU 510, and the PRU 521 forms a communication network with the PTU 520.

In an example of FIG. 5 in which the PRUs 511 and 521 are located in an overlapping region between the efficient power transmission regions 501 and 503, the PRU 511 may form a communication network with the PTUs 510 and 520, and the PRU 521 may form a communication network with the PTUs 510 and 520. In other words, a cross-connection may occur.

In an example in which an RSSI value of a search signal is greater than a preset value, a PTU determines that a PRU transmitting the search signal is normally connected. In another example in which an RSSI value of a search signal of a predetermined PRU is equal to or less than the preset value, a PTU determines that the predetermined PRU is cross-connected. The preset value may be determined based on implementation and setting of the PTUs 510 and 520 and the PRUs 511 and 521.

A PRU may use a search signal to join a communication and power transmission network of a PTU. The search signal may include, for example, a network ID received from a PTU with a higher RSSI value.

In FIG. 5, the PRU 521 may be connected to the PTU 510. In this example, the PTU 510 may determine whether the PRU 521 is cross-connected, and may block connection of the PRU 521. In another example, the PRU 511 may be connected to the PTU 520. In this example, the PTU 520 may determine whether the PRU 511 is cross-connected, and may block connection of the PRU 511.

Method of Preventing Cross-Connection by Sensing Change in Impedance of PRU

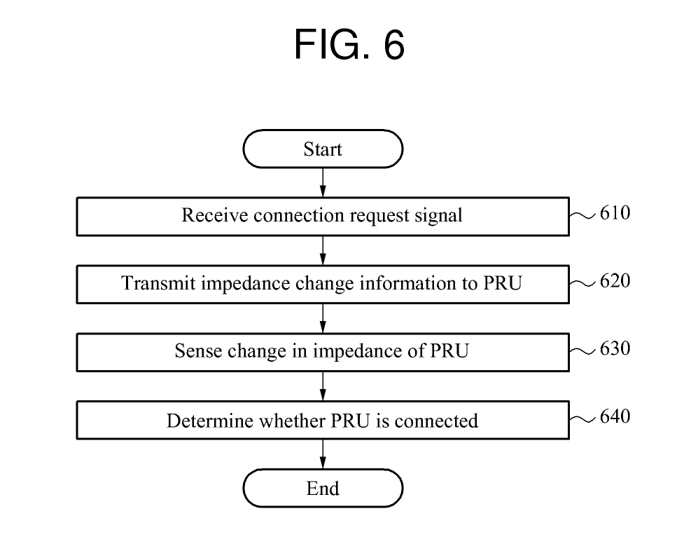

FIG. 6 illustrates an example of a communication method of a PTU.

Referring to FIG. 6, in 610, the PTU receives a connection request signal from each of at least one PRU.

In 620, the PTU transmits impedance change information of the at least one PRU to the at least one PRU. In an example, the PTU may change an impedance of a PRU by transmitting a binary numeral “0111.” In this example, the PRU may receive “0111,” and may change an impedance of the PRU to an impedance denoted by “0111.”

In 630, the PTU senses a change in an impedance of each of the at least one PRU that receives the impedance change information. The change in the impedance may include, for example, a change in a resistance, a change in a reactance, or a change in both the resistance and the reactance.

In 640, the PTU determines whether the at least one PRU is connected. The PTU may sequentially sense a change in an impedance of each of the at least one PRU.

In an example in which the sensed change in the impedance matches a predetermined pattern, the PTU determines that the at least one PRU is connected in 640. The predetermined pattern may include a predetermined value. For example, when an impedance of a PRU is changed to an impedance denoted by a binary numeral “0111,” the PTU senses a change in the impedance of the PRU. The PTU determines whether the sensed change matches the impedance denoted by the binary numeral “0111.” When the sensed change is determined to be matched to the impedance denoted by the binary numeral “0111,” the PTU determines that the PRU is connected.

The connection request signal and the impedance change information may be transmitted and received through an out-of-band communication channel.

Additionally, the PTU may include a table in which the impedance change information of the at least one PRU is stored. The table may be used to store impedance change information of the at least one PRU. The PTU may compare the impedance change information stored in the table with the sensed change in the impedance, and may determine whether the at least one PRU is connected based on a result of the comparison.

In an example, a PRU may transmit a signal indicating a change in the impedance of the PRU to a PTU. When the signal is received, the PTU may measure an RSSI of the signal, and may determine whether the PRU is connected based on a the measurement. When the RSSI is equal to or greater than a predetermined value, the PTU may determine that the PRU is connected. The PRU may not be located in an efficient power transmission region of the PTU, since a communication coverage of the PTU may be wider than the efficient power transmission region of the PTU. The predetermined value may be set based on the efficient power transmission region of the PTU.

When a PRU to which power is to be transmitted is detected, the PTU may disconnect a communication channel with another PRU.

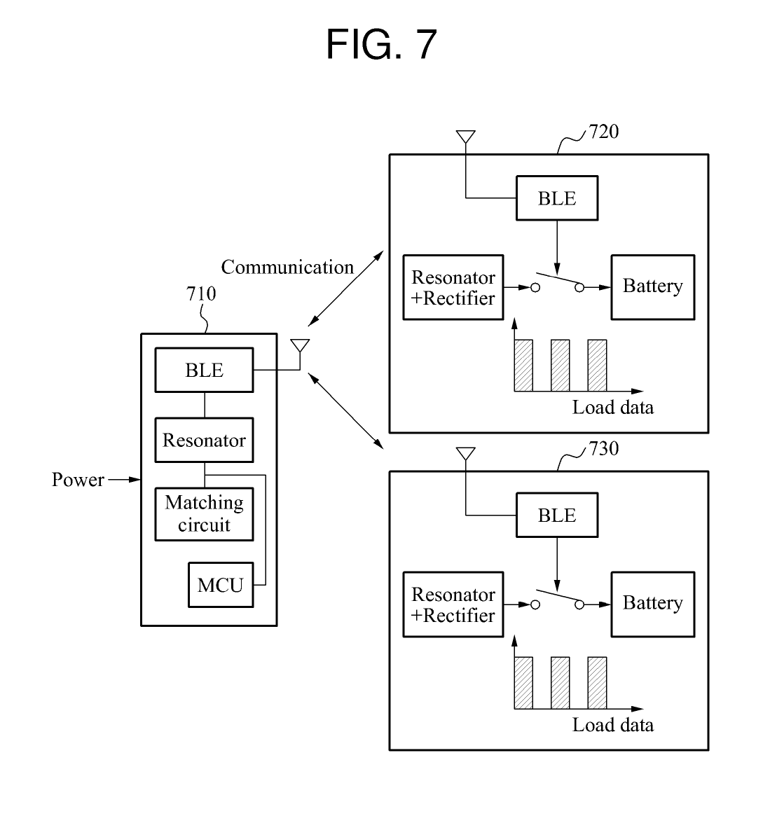

FIG. 7 illustrates an example of a wireless power transmission system.

Referring to FIG. 7, a PTU 710 communicates with PRUs 720 and 730 using Bluetooth low energy (BLE) wireless technology.

The PTU 710 includes a resonator, for example, the source resonator 131 of FIG. 1. Each of the PRUs 720 and 730 includes a resonator, for example, the target resonator 133 of FIG. 1.

The PTU 710 includes a microcontroller (MCU). In the PTU 710, impedance change information received from the PRUs 720 and 730 may be detected between the resonator and a matching circuit. In an example in which the MCU is electrically connected between the resonator and the matching circuit through a diode (not shown in FIG. 7), the impedance change information may be detected.

In each of the PRUs 720 and 730, the resonator and a rectifier may be connected to a battery through a switch. In an example in which impedance change information is received from the PTU 710 through BLE, each of the PRUs 720 and 730 may close the switch in response to the impedance change information. When the switch is closed, each of the PRUs 720 and 730 may control a change in their impedance.

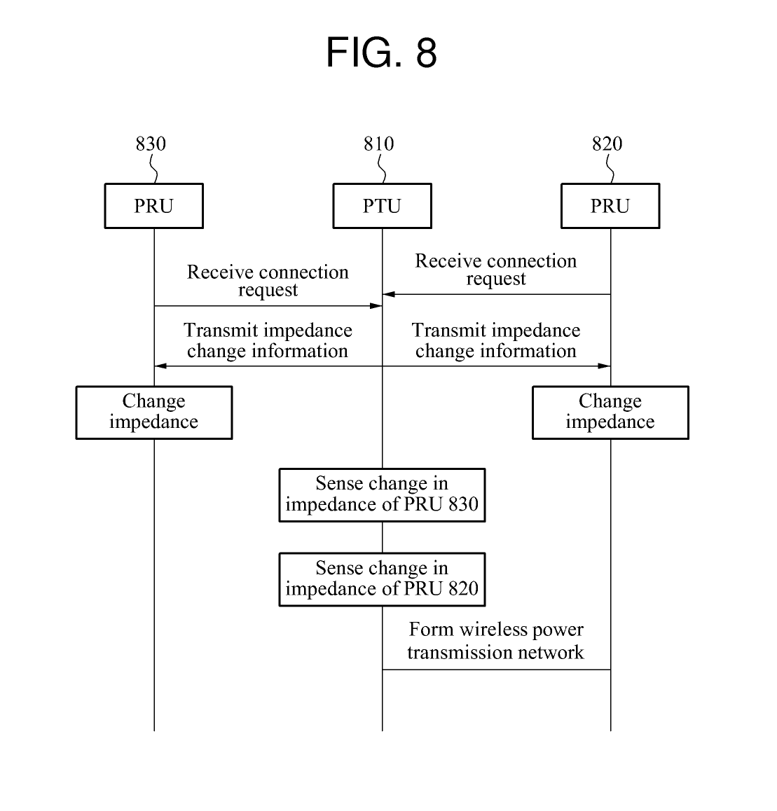

FIG. 8 illustrates an example of a communication method of a PTU and a PRU.

Referring to FIG. 8, a PTU 810 receives a connection request from each of a plurality of PRUs, for example, PRUs 820 and 830. In a multi-target environment including the plurality of PRUs, the PTU 810 is required to detect a PRU to which power is to be transmitted. The PTU 810 stores, in advance, impedance change information of the PRU to which power is to be transmitted. The PTU 810 transmits the stored impedance change information to the PRUs 820 and 830. For example, an out-of-band communication channel may be used to transmit the stored impedance change information to the PRUs 820 and 830.

The PRUs 820 and 830 receive the impedance change information from the PTU 810. The PRUs 820 and 830 change their impedance in response to the impedance change information. For example, the PRUs 820 and 830 may change an impedance of a coil of a resonator of the PRUs 820 and 830. The PRUs 820 and 830 are designed to change their impedance so that the impedance matches the impedance change information received from the PTU 810.

The PTU 810 senses a change in an impedance of the PRU 830. The change in the impedance may include, for example, a change in a resistance, a change in a reactance, or a change in both the resistance and the reactance. The PTU 810 determines whether the PRU 830 is a PRU that may receive power from the PTU 810 based on the sensed change in the impedance. In an example, the PTU 810 may determine that the PRU 830 is not a PRU that may receive wireless power from the PTU 810.

The PTU 810 senses a change in an impedance of the PRU 820. The PTU 810 determines whether the PRU 820 is a PRU that may receive power from the PTU 810 based on the sensed change in the impedance. In an example, the PTU 810 may determine that the PRU 820 is a PRU that may receive wireless power from the PTU 810.

The PTU 810 forms a wireless power transmission network with the PRU 820. The PTU 810 transmits wireless power to the PRU 820 through the wireless power transmission network.

To prevent a cross-connection through the impedance change information of the PRUs 820 and 830, each of the PRUs 820 and 830 transmits a connection request signal to the PTU 810 when entering a charging region of the PTU 810. Additionally, the PRUs 820 and 830 receive the impedance change information from the PTU 810. The PRUs 820 and 830 control a change in their impedance based on the impedance change information.

Method of Preventing Cross-Connection Through Change in Power Transmitted by PTU

To prevent a cross-connection through a change in power transmitted by a PTU, the PTU may set a communication channel with each of at least one PRU. Additionally, the PTU may receive a power change request from each of the at least one PRU through the communication channel. In response to the power change request, the PTU may transmit a changed power to the at least one PRU within a predetermined period of time after the power change request was transmitted to the PTU.

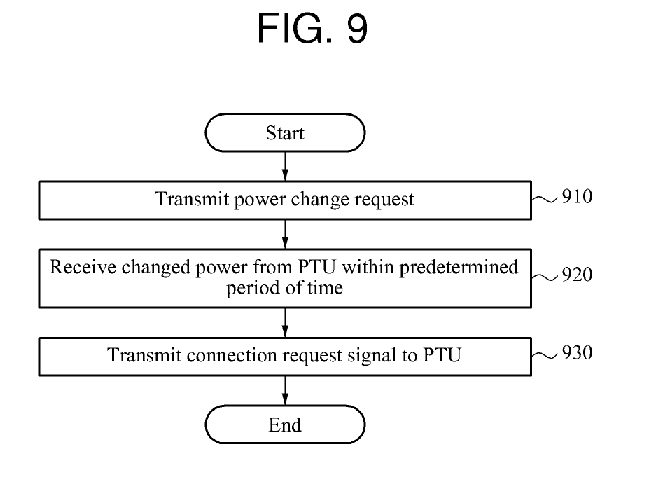

FIG. 9 illustrates an example of a communication method of a PRU.

Referring to FIG. 9, in 910, the PRU transmits a power change request to a PTU through a communication channel. For example, before transmitting the power change request to the PTU, the PRU may receive a wake-up power from the PTU. When the wake-up power is received, the PRU requests the PTU to transmit a changed wake-up power.

The communication channel used in 910 may be, for example, either an in-band communication channel or an out-of-band communication channel.

In 920, the PRU receives a changed power from the PTU. For example, the PTU may change a strength or a period of a wake-up power transmitted prior to receiving the power change request from the PRU, and may transmit the changed wake-up power to the PRU.

In an example in which the changed power is received within a predetermined period of time after the PRU requested the PTU to transmit a changed wake-up power, the PRU transmits a connection request signal to the PTU through the communication channel in 930.

In another example in which the changed power is not received within the predetermined period of time after the PRU requested the PTU to transmit a changed wake-up power, the PRU may disconnect communication with the PTU through the communication channel, or may retransmit the power change request to the PTU.

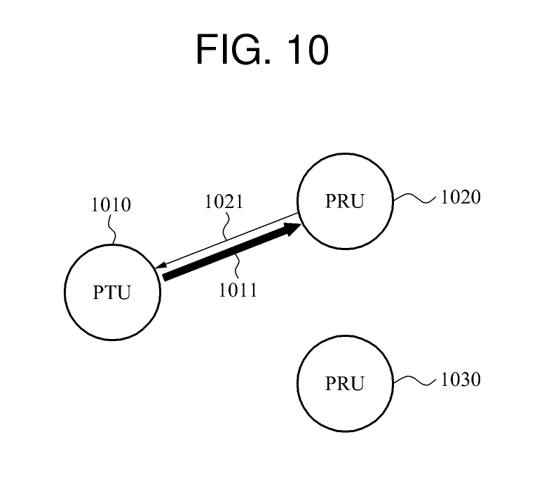

FIG. 10 illustrates another example of a wireless power transmission system.

Referring to FIG. 10, a PTU 1010 receives a power change request from a PRU 1020 in 1021. Additionally, although not illustrated in FIG. 10, the PTU 1010 receives a power change request from a PRU 1030. In a multi-target environment including the PRUs 1020 and 1030, the PTU 1010 may be required to detect a PRU to which power is to be transmitted.

In 1011, the PTU 1010 transmits changed power to the PRUs 1020. In an example, the PTU 1010 transmits changed power to the PRU 1020 within a predetermined period of time after the PRU 1020 transmitted the power change request to the PRU 1010, for example 10 milliseconds (ms). In another example, after the predetermined period of time elapses, the PTU 1010 transmits changed power to the PRU 1030.

In an example in which the PRU 1020 receives the changed power within the predetermined period of time after the PRU 1020 transmitted the power change request to the PRU 1010, the PRU 1020 transmits a connection request signal to the PTU 1010. The PTU 1010 receives the connection request signal from the PRU 1020, and forms a wireless power transmission network with the PRU 1020. The PTU 1010 transmits wireless power to the PRU 1020 through the wireless power transmission network.

In an example in which the PRU 1030 does not receive the changed power within the predetermined period of time after the PRU 1020 transmitted the power change request to the PRU 1010, the PRU 1030 disconnects a communication channel with the PTU 1010. Additionally, the PRU 1030 may retransmit the power change request to the PTU 1010 or a neighboring PTU.

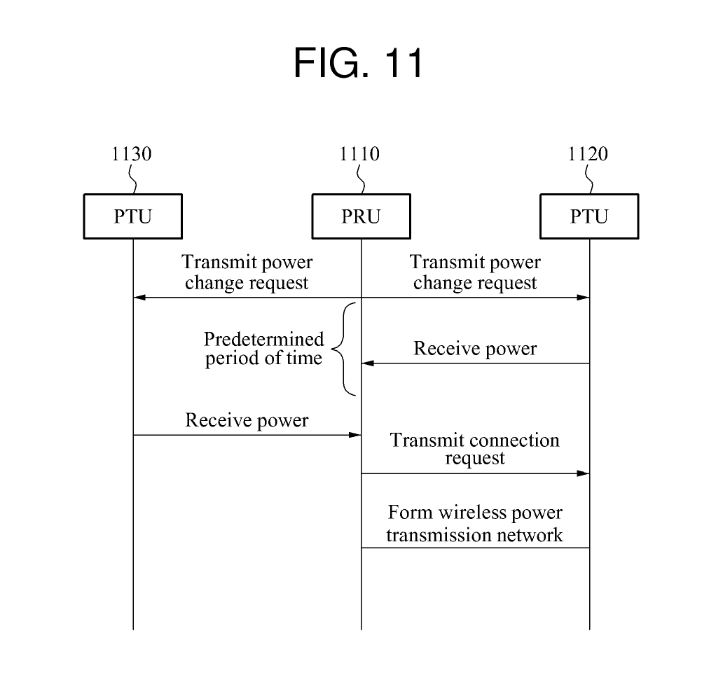

FIG. 11 illustrates another example of a communication method of a PTU and a PRU.

Referring to FIG. 11, a PRU 1110 transmits a power change request to each of a plurality of PTUs, for example, PTUs 1120 and 1130. In response to the power change request, each of the PTUs 1120 and 1130 transmits power to the PRU 1110.

The PRU 1110 receives a changed power from the PTU 1120 within a predetermined period of time after the PRU 1110 transmitted the power change request to the PTUs 1120 and 1130. After the predetermined period of time elapses, the PRU 1110 receives a changed power from the PTU 1130. The PRU 1110 transmits a connection request to the PTU 1120. The PRU 1110 forms a wireless power transmission network with the PTU 1120, and receives wireless power from the PTU 1120 through the wireless power transmission network.

The PRU 1110 disconnects a communication channel with the PTU 1130.

Configuration of PTU

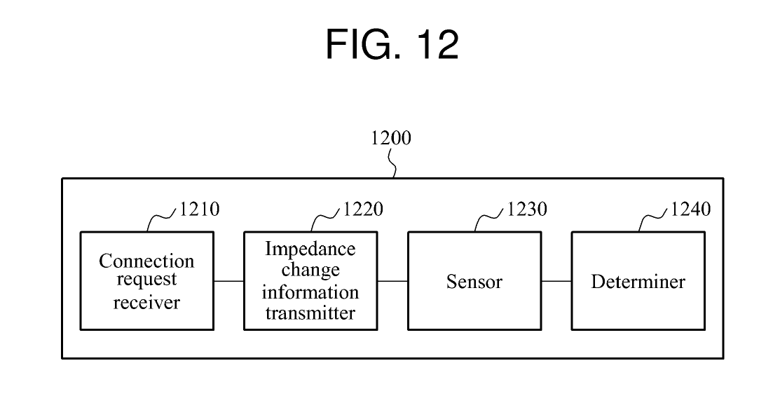

FIG. 12 illustrates an example of a PTU.

Referring to FIG. 12, a PTU 1200 includes a connection request receiver 1210, an impedance change information transmitter 1220, a sensor 1230, and a determiner 1240.

The connection request receiver 1210 receives a connection request signal from each of at least one PRU.

The impedance change information transmitter 1220 transmits impedance change information of the at least one PRU to the at least one PRU.

The sensor 1230 senses a change in an impedance of each of the at least one PRU that receives the impedance change information.

The determiner 1240 determines whether the at least one PRU is connected based on the change in the impedance sensed by the sensor 1230. Additionally, when the change in the impedance of each of the at least one PRU matches a predetermined pattern, the determiner 1240 determines that the at least one PRU is connected.

The connection request and the impedance change information may be transmitted and received through an out-of-band communication channel.

The PTU 1200 may include a table in which the impedance change information of the at least one PRU is stored.

The description of FIGS. 1 through 11 is also applicable to the PTU 1200 of FIG. 12, and accordingly will not be repeated here.

In another example (not illustrated), a PTU includes a channel setting unit, a power change request receiver, and a transmitter.

The channel setting unit sets a communication channel with at least one PRU.

The power change request receiver receives a power change request from each of the at least one PRU through the communication channel.

The transmitter transmits a changed power to the at least one PRU within a predetermined period of time in response to the power change request.

The description of FIGS. 1 through 11 is also applicable to the PTU of this unillustrated example, and accordingly will not be repeated here.

Configuration of PRU

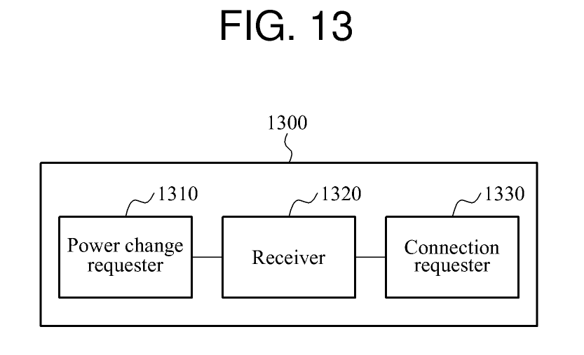

FIG. 13 illustrates an example of a PRU.

Referring to FIG. 13, a PRU 1300 includes a power change requester 1310, a receiver 1320, and a connection requester 1330.

The power change requester 1310 transmits a power change request to a PTU through a communication channel.

The receiver 1320 receives a changed power from the PTU.

In an example in which the receiver 1320 receives the changed power within a predetermined period of time, the connection requester 1330 transmits a connection request signal through the communication channel. In another example in which the receiver 1320 does not receive the changed power within the predetermined period of time, the connection requester 1330 disconnects a communication with the PTU through the communication channel.

The description of FIGS. 1 through 11 is also applicable to the PRU 1300 of FIG. 13, and accordingly will not be repeated here.

In another example (not illustrated), a PRU includes a connection request signal transmitter, an impedance change information receiver, and a controller.

The connection request signal transmitter transmits a connection request signal to a PTU when entering a charging region of the PTU.

The impedance change information receiver receives impedance change information of the PRU from the PTU.

The controller controls a change in an impedance based on the impedance change information.

The description of FIGS. 1 through 11 is also applicable to the PRU of this unillustrated example, and accordingly will not be repeated here.

The Tx controller 114, the communication units 115 and 124, and the Rx controller 125 in FIG. 1, the connection request receiver 1210, the impedance change information transmitter 1220, the sensor 1230, and the determiner 1240 in FIG. 12, and the power change requester 1310, the receiver 1320, and the connection requester 1330 in FIG. 13 that perform the various operations described with respect to FIGS. 2A, 2B, 3A, 3B, 4A, 4B, and 5-11 may be implemented using one or more hardware components, one or more software components, or a combination of one or more hardware components and one or more software components.

A hardware component may be, for example, a physical device that physically performs one or more operations, but is not limited thereto. Examples of hardware components include resistors, capacitors, inductors, power supplies, frequency generators, operational amplifiers, power amplifiers, low-pass filters, high-pass filters, band-pass filters, analog-to-digital converters, digital-to-analog converters, and processing devices.

A software component may be implemented, for example, by a processing device controlled by software or instructions to perform one or more operations, but is not limited thereto. A computer, controller, or other control device may cause the processing device to run the software or execute the instructions. One software component may be implemented by one processing device, or two or more software components may be implemented by one processing device, or one software component may be implemented by two or more processing devices, or two or more software components may be implemented by two or more processing devices.

A processing device may be implemented using one or more general-purpose or special-purpose computers, such as, for example, a processor, a controller and an arithmetic logic unit, a digital signal processor, a microcomputer, a field-programmable array, a programmable logic unit, a microprocessor, or any other device capable of running software or executing instructions. The processing device may run an operating system (OS), and may run one or more software applications that operate under the OS. The processing device may access, store, manipulate, process, and create data when running the software or executing the instructions. For simplicity, the singular term “processing device” may be used in the description, but one of ordinary skill in the art will appreciate that a processing device may include multiple processing elements and multiple types of processing elements. For example, a processing device may include one or more processors, or one or more processors and one or more controllers. In addition, different processing configurations are possible, such as parallel processors or multi-core processors.

A processing device configured to implement a software component to perform an operation A may include a processor programmed to run software or execute instructions to control the processor to perform operation A. In addition, a processing device configured to implement a software component to perform an operation A, an operation B, and an operation C may have various configurations, such as, for example, a processor configured to implement a software component to perform operations A, B, and C; a first processor configured to implement a software component to perform operation A, and a second processor configured to implement a software component to perform operations B and C; a first processor configured to implement a software component to perform operations A and B, and a second processor configured to implement a software component to perform operation C; a first processor configured to implement a software component to perform operation A, a second processor configured to implement a software component to perform operation B, and a third processor configured to implement a software component to perform operation C; a first processor configured to implement a software component to perform operations A, B, and C, and a second processor configured to implement a software component to perform operations A, B, and C, or any other configuration of one or more processors each implementing one or more of operations A, B, and C. Although these examples refer to three operations A, B, C, the number of operations that may implemented is not limited to three, but may be any number of operations required to achieve a desired result or perform a desired task.

Software or instructions for controlling a processing device to implement a software component may include a computer program, a piece of code, an instruction, or some combination thereof, for independently or collectively instructing or configuring the processing device to perform one or more desired operations. The software or instructions may include machine code that may be directly executed by the processing device, such as machine code produced by a compiler, and/or higher-level code that may be executed by the processing device using an interpreter. The software or instructions and any associated data, data files, and data structures may be embodied permanently or temporarily in any type of machine, component, physical or virtual equipment, computer storage medium or device, or a propagated signal wave capable of providing instructions or data to or being interpreted by the processing device. The software or instructions and any associated data, data files, and data structures also may be distributed over network-coupled computer systems so that the software or instructions and any associated data, data files, and data structures are stored and executed in a distributed fashion.

For example, the software or instructions and any associated data, data files, and data structures may be recorded, stored, or fixed in one or more non-transitory computer-readable storage media. A non-transitory computer-readable storage medium may be any data storage device that is capable of storing the software or instructions and any associated data, data files, and data structures so that they can be read by a computer system or processing device. Examples of a non-transitory computer-readable storage medium include read-only memory (ROM), random-access memory (RAM), flash memory, CD-ROMs, CD-Rs, CD+Rs, CD-RWs, CD+RWs, DVD-ROMs, DVD-Rs, DVD+Rs, DVD-RWs, DVD+RWs, DVD-RAMs, BD-ROMs, BD-Rs, BD-R LTHs, BD-REs, magnetic tapes, floppy disks, magneto-optical data storage devices, optical data storage devices, hard disks, solid-state disks, or any other non-transitory computer-readable storage medium known to one of ordinary skill in the art.

Functional programs, codes, and code segments for implementing the examples disclosed herein can be easily constructed by a programmer skilled in the art to which the examples pertain based on the drawings and their corresponding descriptions as provided herein.

While this disclosure includes specific examples, it will be apparent to one of ordinary skill in the art that various changes in form and details may be made in these examples without departing from the spirit and scope of the claims and their equivalents. Suitable results may be achieved if the described techniques are performed in a different order, and/or if components in a described system, architecture, device, or circuit are combined in a different manner, and/or replaced or supplemented by other components or their equivalents. Therefore, the scope of the disclosure is defined not by the detailed description, but by the claims and their equivalents, and all variations within the scope of the claims and their equivalents are to be construed as being included in the disclosure.

What is claimed is:

1. A communication method of a power transmitting unit (PTU) in a wireless power transmission system, the communication method comprising:
receiving a connection request signal from each of at least one power receiving unit (PRU);
transmitting impedance change information of the at least one PRU to the at least one PRU;
sensing a change in an impedance of each of the at least one PRU receiving the impedance change information; and
determining whether each of the at least one PRU is connected based on the sensed change in the impedance.

2. The communication method of claim 1, wherein the receiving comprises receiving the connection request signal through an out-of-band communication channel; and
the transmitting comprises transmitting the impedance change information through the out-of-band communication channel.

3. The communication method of claim 1, wherein the determining comprises determining whether each of the at least one PRU is connected based on whether the sensed change in the impedance matches a predetermined pattern.

4. The communication method of claim 1, wherein the PTU comprises a table configured to store the impedance change information.

5. A communication method of a power receiving unit (PRU) in a wireless power transmission system, the communication method comprising:
transmitting a power change request to a power transmitting unit (PTU) through a communication channel;
receiving a changed power from the PTU; and
transmitting a connection request signal through the communication channel in response to the changed power being received from the PTU within a predetermined period of time.

6. The communication method of claim 5, further comprising disconnecting a communication with the PTU through the communication channel in response to the changed power not being received within the predetermined period of time.

7. A power transmitting unit (PTU) in a wireless power transmission system, the PTU comprising:
a connection request receiver configured to receive a connection request signal from each of at least one power receiving unit (PRU);
an impedance change information transmitter configured to transmit impedance change information of each of the at least one PRU to each of the at least one PRU;
a sensor configured to sense a change in an impedance of each of each of the at least one PRU receiving the impedance change information; and
a determiner configured to determine whether each of the at least one PRU is connected based on the sensed change in the impedance.

8. The PTU of claim 7, wherein the connection request receiver is further configured to transmit the connection request signal through an out-of-band communication channel; and
the impedance change information transmitter is further configured to transmit the impedance change information through the out-of-band communication channel.

9. The PTU of claim 7, wherein the determiner is further configured to determine whether each of the at least one PRU is connected based on whether the sensed change in the impedance matches a predetermined pattern.

10. The PTU of claim 7, wherein the PTU comprises a table configured to store the impedance change information.

11. A communication method of a power receiving unit (PRU) in a wireless power transmission system, the communication method comprising:
transmitting a request to a power transmitting unit (PTU);
receiving a response to the request from the PTU;
determining whether the PRU may receive wireless power from PTU based on the response;
establishing a wireless power transmission network between the PRU and the PTU in response to a result of the determining being that the PRU may receive wireless power from the PTU.

12. The communication method of claim 11, wherein a wireless power transmission network between the PRU and the PTU is not established in response to a result of the determining being that the PRU may not receive wireless power from the PTU.

13. The communication method of claim 11, further comprising disconnecting a communication channel with the PTU in response to a result of the determining being that the PRU may not receive wireless power from the PTU.

14. The communication method of claim 11, wherein the request is a connection request signal; and
the response is impedance change information instructing the PRU to change an impedance of the PRU.

15. The communication method of claim 14, wherein the transmitting comprises transmitting the connection request signal to the PTU in response to the PRU entering a charging region of the PTU.

16. The communication method of claim 14, wherein the receiving comprises sensing a changed impedance of the PRU; and
the determining comprises determining whether the PRU may receive wireless power from the PTU based on the sensed changed impedance of the PRU.

17. The communication method of claim 16, wherein the determining further comprises determining that the PRU may receive wireless power from the PTU in response to the sensed changed impedance of the PRU matching a predetermined pattern.

18. The communication method of claim 11, wherein the request is a power change request; and
the response is a changed power of the PTU.

19. The communication method of claim 18, wherein the transmitting comprises transmitting the power change request to the PTU in response to receiving a wake-up power from the PTU.

20. The communication method of claim 18, wherein the receiving comprises determining whether the changed power of the PTU was received within a predetermined period of time after the power change request was transmitted to the PTU; and
the determining of whether the PRU may receive wireless power from the PTU comprises determining that the PRU may receive wireless power from the PTU in response to a result of the determining of whether the changed power of the PTU was received within the predetermined period of time being that the changed power was received within the predetermined period of time.
